(19) United States
(12) Patent Application Publication
(10) Pub. No.: US 2017/0171381 A1
(43) Pub. Date: Jun. 15, 2017

(54) TELECONFERENCING SYSTEM AND METHOD FOR FACILITATING CONFERENCE CALL

(71) Applicant: Plastoform Industries Limited, Hong Kong (CN)

(72) Inventor: Wai-Pun Chung, Hong Kong (CN)

(21) Appl. No.: 15/375,100

(22) Filed: Dec. 11, 2016

Related U.S. Application Data
(60) Provisional application No. 62/266,713, filed on Dec. 14, 2015.

(51) Int. Cl. H04M 3/00; H04M 3/56

(52) U.S. Cl. CPC H04M 3/002; H04M 3/56

(57) ABSTRACT

A teleconferencing system and a method for facilitating teleconferencing between devices is disclosed. The teleconferencing system includes a remote phone that is connected to two or more satellite phones via a phone conference hub. When the user of remote phone initiates a call, the call is routed through the phone conference to each of the two or more satellite phones. The call is pre-processed to remove noise in audio signal. Further, the audio signal is processed to remove echo and noise is removed such that the participants in the teleconferencing system can receive the audio signal clearly without any disturbances.

### OTHER RELATED APPLICATION

The present application takes priority from a U.S. Provisional Patent Application No. 62/266713, filed on Dec. 14, 2015, which is hereby incorporated by reference.

### FIELD OF THE DISCLOSURE

The present disclosure generally relates to the field of telecommunication. More particularly, the present disclosure provides a teleconferencing system and a method for facilitating teleconferencing between devices that are connected and situated away from a central phone conference hub.

### BACKGROUND

As known, teleconferencing is a form of audio voice communication over a network. The network may be a local area network (LAN), a wide area network (WAN) such as the Internet, the public switched telephone network (PSTN), or any combination thereof. Typically, teleconferencing involves two or more participants who are situated at different places. In order to participate in the teleconference, each participant uses respective devices i.e., telephone.

Several systems that facilitate teleconferencing have been proposed in the past. However, the existing teleconferencing systems have several problems. For example, when a participant is speaking, other participants may have lot of disturbance. The disturbance may be caused due to faulty equipment or may be caused due to poor voice quality or may be caused due to interference in the audio signal transmitted between each component present in the system. The problems occur quite often if the participant uses their device from a distance. Due to the problems, participants may disconnect and reconnect to the system repeatedly which results in loss of productivity and hinders the teleconferencing experience.

In view of the above-mentioned problems, it is evident that, there is a need for a solution, which could establish and maintain short-range communication with a plurality of devices. Further, there is a need to solve the problem of unintended eavesdropping and poor voice quality.

### SUMMARY

It will be understood that this disclosure in not limited to the particular systems, and methodologies described, as there can be multiple possible embodiments of the present disclosure that are not expressly illustrated in the present disclosure. It is also to be understood that the terminology used in the description is for the purpose of describing the particular versions or embodiments only, and is not intended to limit the scope of the present disclosure.

It is one object of the present disclosure to provide a teleconferencing system that facilitates teleconferencing without any disturbance. The teleconferencing system comprises a remote phone, a phone conference hub, and two or more satellite phones. The remote phone is communicatively coupled to the phone conference hub. Further, the phone conference hub is communicatively coupled to the two or more satellite phones. The remote phone initiates a call that gets connected to the phone conference hub. The phone conference hub pre-processes the call to identify a source of an audio signal of the call. The call is pre-processed to remove noise from the audio signal of the call. After pre-processing the call, the phone conference hub transmits the call to the two or more satellite phones. Each of the satellite phones comprises a speaker and a microphone. Each of the satellite phones removes echo and noise in the audio signal of the call. Further, each of the satellite phones amplifies the audio signal such that a user of the satellite phone may respond with voice command or audio input.

In another object of the present disclosure, the audio input received from the user of the satellite phone is processed to clear echo and noise. Further, the audio input is transmitted to the phone conference hub, which in turn transmits the voice signal to the remote phone and to other satellite phones.

It is yet another object of this disclosure to provide such a conference system that is easy to implement and maintain while retaining its effectiveness.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated that the conception and specific embodiment disclosed may be readily utilized as a basis for modifying or designing other structures for carrying out the same purposes of the present disclosure. It should also be realized that such equivalent constructions do not depart from the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawing, in which:

FIG. 1 illustrates a conference system that facilitates calling between a remote phone and one or more satellite phones, in accordance with one embodiment of the present disclosure;

FIG. 2 illustrates the remote phone communicatively connected to a phone conference hub, in accordance with one embodiment of the present disclosure;

FIG. 3 illustrates the conference system facilitating calling between a remote phone and one or more satellite phones, in accordance with another embodiment of the present disclosure;

FIG. 4 depicts a method of sending an audio signal from a remote phone to one or more satellite phones, in accordance with another embodiment of the present disclosure; and

FIG. 5 depicts a method of sending an audio signal from a satellite phone to the remote phone and other satellite phones, in accordance with another embodiment of the present disclosure.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

The present disclosure relates to a teleconferencing system and a method for facilitating teleconferencing between devices. The teleconferencing system includes a remote phone that is connected to two or more satellite phones via a phone conference hub. When the user of remote phone initiates a call, the call is routed through the phone conference to each of the two or more satellite phones. The call is pre-processed and echo and noise is removed such that the participants in the teleconferencing system can receive the audio signal clearly without any disturbances. This arrangement enables the participants in the meeting who are sitting far away from the sound source to listen clearly what has been said during the call.

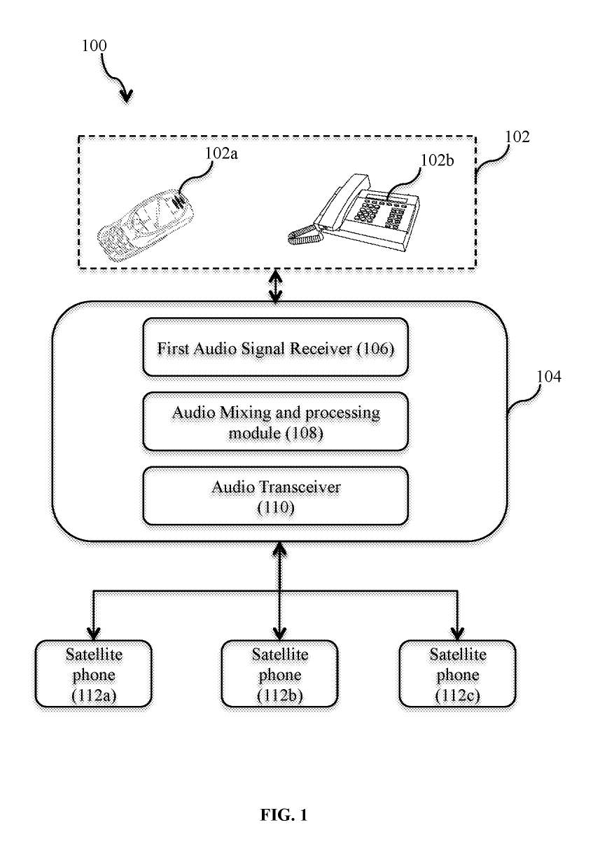

The various features and embodiments for facilitating teleconferencing between devices are explained in conjunction with the description of FIGS. 1-5.

Referring to FIG. 1, a teleconferencing system 100 facilitating teleconference between devices is shown, in accordance with one embodiment of the present disclosure. The teleconferencing system 100 comprises a remote phone 102. The remote phone 102 may comprise one of a mobile phone, a landline, a Public Switched Telephone Network (PSTN), an Internet telephone, and other devices that are capable of placing a call. For the purpose of explanation, a mobile phone 102a and a landline telephone 102b, collectively referred as remote device 102, is used.

The remote device 102 is communicatively connected to a phone conference hub 104. The phone conference hub 104 may indicate a telephone bridge that facilitates connection between remote device 102 and other devices e.g., another mobile phone or satellite phone or Internet enabled devices. The phone conference hub 104 comprises a first audio signal receiver 106, an audio mixing and processing module 108, and an audio transceiver 110.

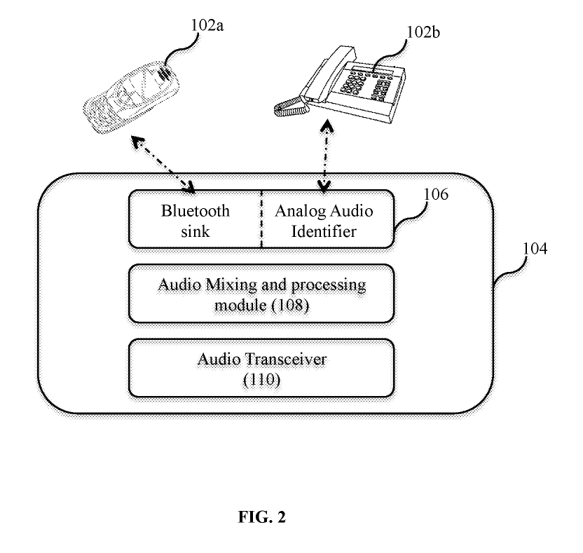

Now referring to FIG. 2, the remote devices 102a and 102b communicating with the phone conference hub 104 is explained. The mobile phone 102a and the landline telephone 102b may establish communication with the phone conference hub 104 using variety of means. For instance, the mobile phone 102a may establish communication with the phone conference hub 104 using Bluetooth connectivity. On the other hand, the landline telephone 102b may establish communication with the phone conference hub 104 using audio signal. In order to recognize variety of remote devices, the first audio signal receiver 106 is configured to identify different type of signals sent by the remote device 102. As can be seen from FIG. 2, the first audio signal receiver 106 includes a Bluetooth sink and an Analog audio identifier. Whenever a call is placed, the first audio signal receiver 106 identifies the type of audio signal in the call. For example, if the call is placed from the mobile phone 102a, then the first audio signal receiver 106 uses the Bluetooth sink to connect with the mobile phone 102a. Similarly, if the call is placed from the landline telephone 102b, then the first audio signal receiver 106 uses analog audio identifier to connect with the landline telephone 102b. Similarly, the remote device 102 may establish connection with the phone conference hub 106 using other modes such as using Wi-Fi.

After establishing connection with the remote device 102, the phone conference hub 104 employs the audio mixing and processing module 108 to identify the source of the audio signal of the call. After identifying the source of the call such as the call being made from the mobile phone 102a, the audio mixing and processing module 108 pre-processes the audio signal. Specifically, the audio mixing and processing module 108 pre-processes the audio signal to remove the noise from the audio signal in the call. In order to remove the noise, the audio mixing and processing module 108 takes the voice of the caller as input signal and at the same time accepts the noise as output signal from the remote device 102 that is put onto the audio signal. Subsequently, the audio mixing and processing module 108 cancels the output signal thereby removing the noise. After removing the noise from the audio signal, the audio signal is presented to the audio transceiver 110. The audio signal presented to the audio transceiver 110 consists only voice of the caller.

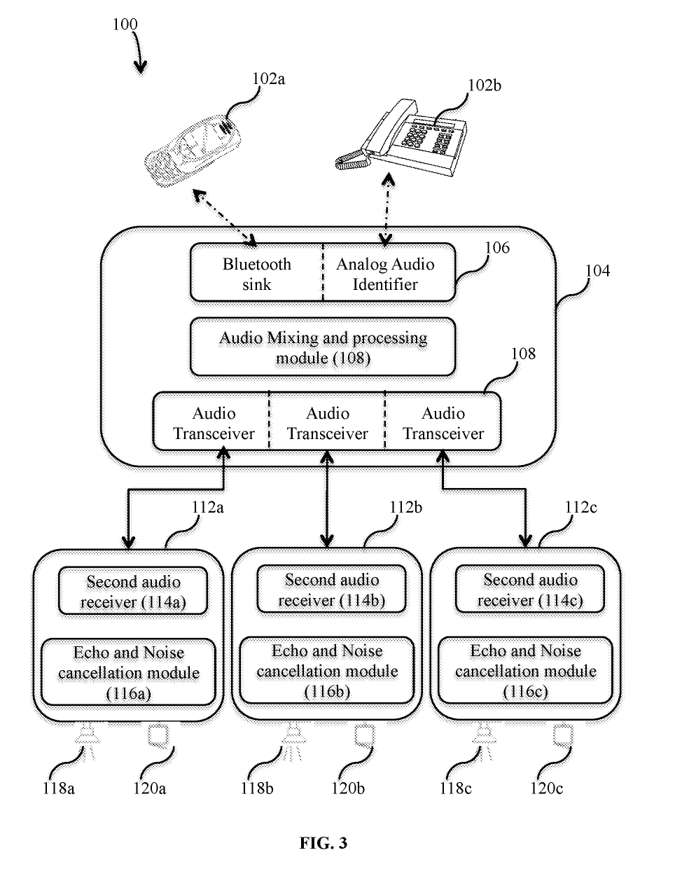

Now referring to FIG. 1 and FIG. 3, the phone teleconference hub 104 is communicatively coupled to two or more satellite devices are shown. For the purpose of explanation, a first satellite device 112a, a second satellite device 112b, and a third satellite device 112c are presented. As can be seen from FIG. 3, each of the satellite devices comprises a second audio receiver, an echo and noise cancellation module, a speaker and a microphone. Specifically, the first satellite device 112a comprises a second audio receiver 114a, an echo and noise cancellation module 116a, a speaker 118a, and a microphone 120a. Similarly, the first satellite device 112b comprises a second audio receiver 114b, an echo and noise cancellation module 116b, a speaker 118b, and a microphone 120b. Similarly, the first satellite device 112c comprises a second audio receiver 114c, an echo and noise cancellation module 116c, a speaker 118c, and a microphone 120c.

Each of the first satellite phone 112a, the second satellite phone 112b, and the third satellite phone 112c are connected to the audio transceiver 110. It should be noted that the first satellite phone 112a, the second satellite phone 112b, and the third satellite phone 112c are connected to the audio transceiver 110 separately such that the call processed by the audio mixing and processing module 108 is transmitted to the first satellite phone 112a, the second satellite phone 112b, and the third satellite phone 112c simultaneously. Specifically, the audio transceiver 110 communicates with the first satellite phone 112a via the second audio receiver 114a. Similarly, the audio transceiver 110 communicates with the first satellite phone 112b via the second audio receiver 114b. Similarly, the audio transceiver 110 communicates with the first satellite phone 112c via the second audio receiver 114c. In order to communicate with each of the second receiver 114a, the second receiver 114b, and the second receiver 114c, the audio transceiver 110 may use separate Bluetooth sinks as shown in FIG. 3.

In operation, after pre-processing the audio signal by the audio mixing and processing module 108, the audio transceiver 110 sends the audio signal to the first satellite phone 112a, the second satellite phone 112b, and the third satellite phone 112c. As specified above, the first satellite phone 112a receives the audio signal using the second audio receiver 114a. Similarly, the first satellite phone 112b receives the audio signal using the second audio receiver 114b. Similarly, the first satellite phone 112c receives the audio signal using the second audio receiver 114c. After receiving the audio signal, each of the echo and noise cancellation modules (116a, 116b, 116c) processes the audio signal to remove echo and noise present in the audio signal. Subsequently, the audio signal is amplified using the speakers (118a, 118b, 118c) coupled to the echo and noise cancellation modules (116a, 116b, 116c) respectively. As the echo and noise is removed in the audio signal, voice of the caller is clearly audible to each user of the satellite phones (112a, 112b, 112c).

Further, each user of the satellite phones (112a, 112b, 112c) may speak using the microphones (120a, 120b, 120c), respectively. For instance, if the user of satellite phone 112c speaks in response to the audio signal received from the caller of remote phone, audio input received from the user of satellite phone 112c is received by the microphone 120c, and then the audio input is processed to remove echo and noise by the echo and noise cancellation module 116c. After removing the noise, the audio input is transmitted to the audio transceiver 110. Subsequently, the audio mixing and processing module 108 removes the noise and the audio input is transmitted to other satellite phones (112a, 112b) and the remote phone 102. As the noise is removed prior to transmitting, the audio input is clearly audible to other participants in the teleconferencing system 100.

As the audio signal is pre-processed to remove any noise present in the voice of the caller, which is subsequently transmitted to satellite phones at far distances, the audio signal amplified by the speaker is clearly audible by users of the satellite phone. Further, the audio input received from the user is processed to remove echo and further processed to remove noise before transmitting to other satellite devices and the remote device, which is clearly audible by other participants. In addition, each of the satellite phones are connected separately to the phone conference hub using Wi-Fi or Bluetooth that results in reduction of load on the phone conference hub. Further, the communication between the satellite phones and the remote phone is not lost even though they are situated at a distance from one another.

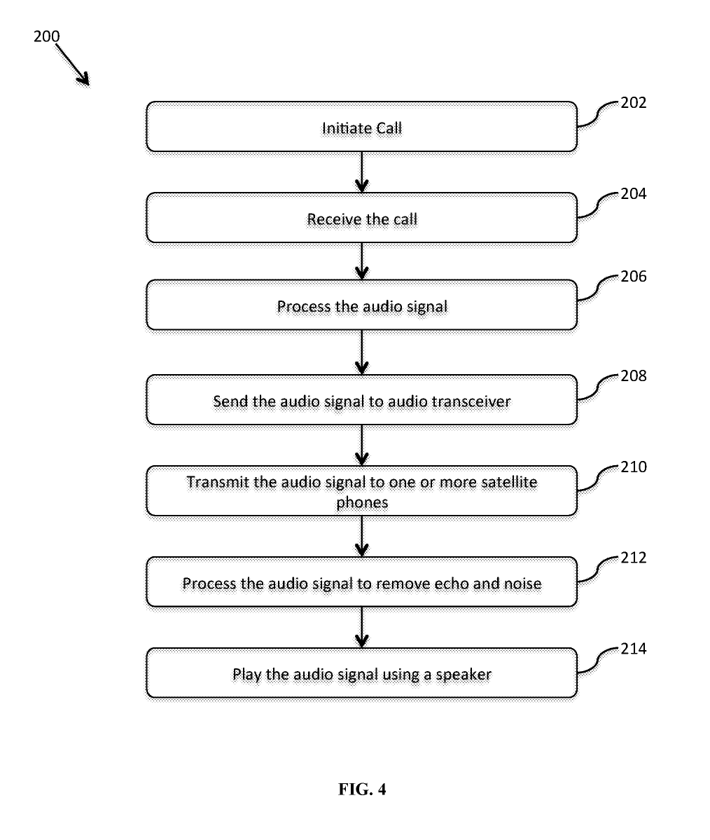

Now referring to FIG. 4, a method 200 of sending an audio signal from a remote phone to one or more satellite phones, in accordance with another embodiment of the present disclosure. The order in which the method 200 is described and is not intended to be construed as a limitation, and any number of the described method blocks can be combined in any order to implement the method 200 or alternate methods. Additionally, individual blocks may be deleted from the method 200 without departing from the spirit and scope of the disclosure described herein. Furthermore, the method may be implemented in any suitable hardware, software, firmware, or combination thereof. However, for ease of explanation, in the embodiments described below, the method 200 may be implemented in the above-described system 100.

At step 202, the remote phone initiates a call.

At step 204, the phone conference hub receives the call.

At step 206, the phone conference hub pre-processes the audio signal by means of the audio mixing and processing module.

At step 208, the audio signal is sent to the audio transceiver.

At step 210, the audio signal is transmitted to each of the satellite phones.

At step 212, the audio signal is further processed to remove echo and noise using an noise cancellation algorithm.

At step 214, the audio signal processed is played at each of the satellite phone by means of a speaker.

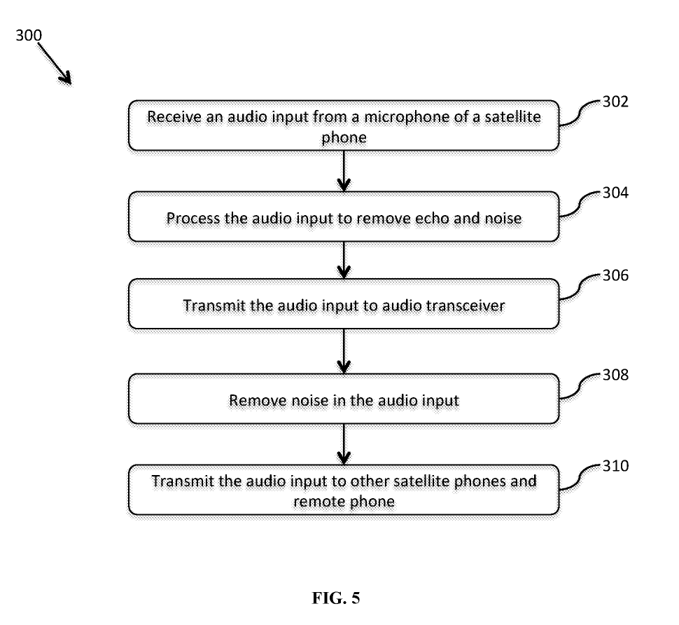

Now, referring to FIG. 5, a method 300 of sending an audio signal from a satellite phone to the remote phone and other satellite phones, in accordance with another embodiment of the present disclosure. The order in which the method 300 is described and is not intended to be construed as a limitation, and any number of the described method blocks can be combined in any order to implement the method 300 or alternate methods. Additionally, individual blocks may be deleted from the method 300 without departing from the spirit and scope of the disclosure described herein. Furthermore, the method may be implemented in any suitable hardware, software, firmware, or combination thereof. However, for ease of explanation, in the embodiments described below, the method 300 may be implemented in the above-described system 100.

At step 302, an audio input is received from a satellite phone by means of a microphone.

At step 304, the audio input received is processed by means of an echo and noise cancellation algorithm for clarifying the received audio signal.

At step 306, the audio input signal processed is sent to the audio transceiver.

At step 308, the audio input is further processed using the audio mixing and processing module.

At step 310, the audio input is sent to other satellite phones and the remote phone.

Although embodiments of the conferencing system have been described in language specific to features and/or methods, it is to be understood that the description is not necessarily limited to the specific features or methods described. Rather, the specific features and methods are disclosed as examples of implementations of a conferencing system.

What is claimed is:

1. A method of enabling a teleconferencing between devices, the method comprising:
receiving a call from a remote device;
pre-processing the call to identify a source of an audio signal of the call, wherein the call is pre-processed to remove noise from the audio signal of the call;
transmitting the call pre-processed to a first satellite phone and a second satellite phone, for enabling the first satellite phone, the second satellite phone and the remote device to have a teleconference, wherein echo and noise in the call transmitted to the first satellite phone and the second satellite phone is removed, and wherein, in response to the call, audio input received from the first satellite phone is transmitted to the remote device and the second satellite phone and vice versa.

2. The method of claim 1, further comprising mixing the audio signal received from the remote device by the phone conference hub.

3. The method of claim 1, wherein the echo and noise is removed using noise cancellation algorithm.

4. A teleconferencing system, comprising:
a remote phone; and
a phone conference hub to:
receive a call initiated from the remote device;
pre-process the call to identify a source of an audio signal of the call, wherein the call is pre-processed to remove noise from the audio signal of the call;
transmit the call pre-processed to a first satellite phone and a second satellite phone; and
enable the first satellite phone, the second satellite phone and the remote device to have a teleconference, such that in response to the call, audio input received from the first satellite phone is transmitted to the remote device and the second satellite phone and vice versa.

5. The teleconferencing system of claim 4, wherein the phone conference hub mixes the audio signal received from the remote device.

6. The teleconferencing system of claim 4, wherein each of the first satellite phone and the second satellite phone comprises a speaker and a microphone.

7. The teleconferencing system of claim 6, wherein the speaker amplifies the call transmitted by the phone conference hub.

8. The teleconferencing system of claim 6, wherein the microphone receives the audio input from a user in response to the call.

9. The teleconferencing system of claim 4, wherein each of the first satellite phone and the second satellite phone removes echo and noise from the call received.

10. The teleconferencing system of claim 9, wherein the echo and noise is removed using noise cancellation algorithm.
